(19) United States
(12) Patent Application Publication
(10) Pub. No.: US 2015/0106258 A1
(43) Pub. Date: Apr. 16, 2015

(54) ELECTRONIC LOAN PROCESSING, MANAGEMENT AND QUALITY ASSESSMENT

(71) Applicant: FISERV, INC., Brookfield, WI (US)

(72) Inventors: Jay Joseph Coomes, Longwood, FL (US); James Lee Gillespie, Heath, OH (US); Gregory Scott Lehman, Altamonte Springs, FL (US)

(21) Appl. No.: 14/573,841

(22) Filed: Dec. 17, 2014

Related U.S. Application Data
(63) Continuation of application No. 13/844,037, filed on Mar. 15, 2013, now abandoned.

(51) Int. Cl. G06Q 40/02

(52) U.S. Cl. CPC G06Q 40/025
USPC 705/38

(57) ABSTRACT

Systems, methods, and computer-readable media for performing various automated processing of loan documents are disclosed. The automated processing may include, for example, electronic processing of loan documents, quality assessment processing to determine an accuracy of information included in the loan documents, tracking and management processing to determine quality characteristics associated with a loan package and candidacy for consideration for delivery to one or more intended recipients, and pre-delivery and delivery processing to further confirm or reject a loan package's candidacy for delivery and to prepare the loan package for delivery.

### CROSS-REFERENCE TO RELATED APPLICATION(S)

This application is a continuation of U.S. Nonprovisional Application Ser. No. 13/844,037 filed Mar. 15, 2013, the entire disclosure of which is hereby incorporated by reference.

### BACKGROUND

One or more loan documents in a loan package may include a variety of types of information such as information that specifies the rights and responsibilities of the loan originator and the loan recipient, information identifying one or more attributes of the loan, and so forth. From the time of origination of the loan and throughout the life of the loan, various tasks may need to be completed to ensure, among other things, that complete and proper documentation is maintained, that relevant regulatory rules are being complied with, that required processing is completed in a timely manner, and so forth.

### BRIEF DESCRIPTION OF THE DRAWINGS

The detailed description is set forth with reference to the accompanying drawings. The use of the same reference numerals indicates similar or identical items; however, different reference numerals may be used to indicate similar or identical items as well. Various embodiments may utilize element(s) and/or component(s) other than those illustrated in the drawings and some element(s) and/or component(s) may not be present in various embodiments. It should be appreciated that while singular terminology may be used to describe a component or element, a plural number of such components or elements may also be encompassed within the scope of the disclosure.

FIG. 1 is a schematic block diagram of an illustrative system architecture for performing various processing associated with a loan package in accordance with one or more embodiments of the disclosure.

FIG. 2 is a more detailed schematic block diagram illustrating various hardware and software sub-components of various components of the illustrative architecture of FIG. 1 in accordance with one or more embodiments of the disclosure.

FIG. 3 is a process flow diagram of an illustrative method for performing classification/extraction processing in accordance with one or more embodiments of the disclosure.

FIG. 4 is a process flow diagram of an illustrative method for performing comparison processing in accordance with one or more embodiments of the disclosure.

FIG. 5 is a process flow diagram of an illustrative method for performing loan tracking and management processing in accordance with one or more embodiments of the disclosure.

FIG. 6 is a process flow diagram of an illustrative method for performing pre-delivery audit processing and/or delivery processing in accordance with one or more embodiments of the disclosure.

FIG. 7 is a schematic depiction of illustrative data elements that may be identified in an illustrative loan document as part of classification/extraction processing performed in accordance with one or more embodiments of the disclosure.

### DETAILED DESCRIPTION

### Overview

Embodiments of the disclosure relate to, among other things, systems, methods, computer-readable media, techniques and methodologies for performing various automated processing of loan documents. The automated processing may include, for example, electronic processing of loan documents, quality assessment processing to determine an accuracy of information included in the loan documents, tracking and management processing to determine quality characteristics associated with a loan package and candidacy for consideration for delivery to one or more intended recipients, and pre-delivery and delivery processing to further confirm or reject a loan package's candidacy for delivery and to prepare the loan package for delivery.

A typical loan processing environment may include a variety of systems that support various functionality associated with the origination, processing, and servicing of loans. For example, one or more loan origination systems may be provided as part of a loan processing environment and may support functionality for performing initial origination processing associated with an application for a loan. In addition, one or more loan servicing systems may be provided as part of a loan processing environment and may support functionality for managing various attributes or characteristics of a loan over the duration of the loan. Moreover, various third party systems may be provided that support functionality for performing a variety of types of processing associated with loans such as, for example, processing to determine a loan applicant's credit-worthiness, processing to determine compliance with applicable regulatory requirements, and so forth.

In conventional loan processing solutions or systems, loan processing tasks are often manually performed and are not effectively integrated with each other and/or with external systems such as those described above. Further, loan processing performed by conventional loan processing systems is often specifically tailored to a specific set of circumstances (e.g., a specific type of loan), and thus, fails to provide a comprehensive solution that can extended to any of variety of scenarios. Accordingly, a number of disadvantages are associated with conventional loan processing systems including, but not limited to, incomplete, inaccurate, or poor quality documentation; lack of timely processing of loan documents; failure to comply with applicable regulatory requirements; and so forth. In addition, the above-mentioned disadvantages associated with conventional loan processing systems may engender further disadvantages such as increased customer dissatisfaction.

Embodiments of the disclosure provide a comprehensive, automated, and integrated solution that addresses, among other things, the disadvantages associated with conventional loan processing systems outlined above. Technical effects and/or advantages of embodiments of the disclosure include, but are not limited to, a reduction in incomplete loan documentation; an increase in the efficiency and timeliness with which loan documents are processed; and an increase in the accuracy and quality of loan packages as a result of: i) processing performed to identify errors or incomplete information in loan documents, ii) exceptions processing to correct any such errors or omissions that are identified, iii) pre-delivery processing to ensure that quality standards and/or delivery requirements are met before delivery of a loan package to one or more intended recipients, and iv) delivery processing to ensure that delivery parameters and/or requirements are complied with during delivery of the loan package. It should be appreciated that the above examples of disadvantages associated with conventional loan processing systems and the above examples of technical effects and/or advantages of embodiments of the disclosure are merely illustrative and not exhaustive.

In accordance with one or more embodiments of the disclosure, a loan processing system may be provided. The loan processing system may include one or more of various subsystems that support respective functionality associated with the processing of loans. The subsystems may include, for example, a classification/extraction subsystem, a quality assessment subsystem, a tracking/loan management subsystem, and a delivery subsystem. The loan processing system may be configured to communicate with one or more other systems via one or more networks. For example, the loan processing system may be configured to communicate with loan origination system(s), loan servicing system(s), and/or various other third-party systems. In various embodiments, the loan processing system (or more specifically the one or more subsystems forming part of the loan processing system) may be configured to access one or more archive datastores in order to store data generated during processing performed by the subsystem(s) as well as to retrieve data for manipulation as part of the processing.

In one or more embodiments, the loan processing system may include one or more loan processing computers. The loan processing computer(s) may include any suitable processor-driven device(s) such as, for example, a server computer, a desktop computer, a laptop computer, a mainframe computer, and so forth. In certain embodiments, each subsystem of the loan processing system may comprise one or more loan processing computers. Each subsystem may further include any number of other components such as, for example, networking components, datastore(s), and so forth. In certain embodiments, functionality associated with each subsystem of the loan processing system may be performed as a result of execution of computer-executable instructions provided as part of one or more program modules executable on respective loan processing computer(s) forming part of the subsystem.

In accordance with one or more embodiments of the disclosure, output generated as a result of processing performed by a particular subsystem in the loan processing system may be provided as input for processing performed by another subsystem. In this manner, the various subsystems of the loan processing system may operate in an integrated fashion to perform various stages of loan processing.

In accordance with one or more embodiments of the disclosure, a set of loan documents associated with a loan may be received. The classification/extraction subsystem may support functionality for performing initial automated classification and extracting processing on the set of loan documents. Prior to performing the classification processing (or as part of the classification processing), the classification/extraction subsystem may convert any hardcopy documents in the set of loan documents to an image form, and may further perform optical character recognition (OCR) processing on any electronic loan documents that do not support automated text processing. As a result, a set of electronic documents that support automated text processing may be generated. As used herein, the phrase “automated text processing” may refer to processing for searching for and/or extracting text characters.

The classification/extraction subsystem may be further configured to perform classification processing on the set of electronic documents. The classification processing may associate a respective loan document classification with each loan document. Each candidate loan document classification may have various classification criteria associated therewith that may be analyzed by the classification/extraction subsystem to identify a respective loan document classification to associate with each of one or more of the loan documents.

Upon performing the above-described classification processing, the classification/extraction subsystem may be configured to perform extraction processing on the set of classified loan documents. Extraction information may be stored in association with each loan document classification. The extraction information may identify one or more data fields from which to extract corresponding data elements in a loan document classified in accordance with the associated loan document classification. Further, one or more extraction criteria (e.g., a location in the document at which to search for the data field, one or more characters associated with the data field, etc.) may be associated with each data field to be extracted. As part of the extraction processing, the classification/extraction subsystem may identify the one or more data fields in a loan document from which to extract corresponding data element(s) based on the associated extraction criteria.

In accordance with one or more embodiments of the disclosure, one or more metrics associated with the classification and extraction processing may be generated. Further, upon completion of the classification and extraction processing, the various electronic loan documents may be stored in association with respective metadata that identifies the respective classification associated with each loan document, the respective set of data element(s) extracted from each loan document, any respective classification/extraction processing metrics associated with classification/extraction processing performed on each loan document, and so forth. An indication of the loan documents and the associated metadata may then be provided as input to the quality assessment subsystem.

The quality assessment subsystem may be configured to receive the data identifying each loan document and the respective metadata associated with each loan document and perform comparison processing to identify any extracted data elements that may be associated with an error or omission of information in a loan document. For each loan document, the quality assessment subsystem may identify the respective classification associated with the loan document. A comparison template associated with the respective classification may then be identified. The comparison template may specify one or more comparisons to be performed where each comparison identifies a correspondence between one or more data fields in the loan document and one or more data fields in data received from external data sources. Each comparison may involve a determination as to whether a desired relationship exists between one or more data elements associated with the data field(s) in the loan document and one or more data elements associated with the corresponding data field(s) in the external source data. The determination as to whether the desired relationship exists may be made with respect to a minimum correspondence threshold or a maximum tolerance threshold. As part of the comparison processing, each comparison that results in a success and each comparison that results in an exception may be identified and respective data files indicative of the comparison successes and the comparison exceptions may be provided as input to the tracking/loan management subsystem.

The tracking/loan management subsystem may be configured to support functionality associated with various forms of event-driven processing. For example, the tracking/loan management subsystem may be configured to associate additional loan documents with a loan package upon receipt of an indication of the availability of such documents. Further, the tracking/loan management subsystem may be configured to store data associated with comparison processing successes and exceptions. In addition, the tracking/loan management system may be configured to facilitate exception handling processing. In certain embodiments, a portion of the exception handling processing may be automated while in other embodiments the exception handling processing may be a manually-driven process facilitated via one or more user interfaces and associated software tools.

It should be noted that, in accordance with one or more embodiments of the disclosure, classification/extraction processing supported by the classification/extraction subsystem 104, comparison processing supported by the quality assessment subsystem 106, and tracking/loan management processing (including for example exceptions processing) supported by the tracking/loan management subsystem 108 may be performed iteratively for different subsets of loan documents associated with a same loan package until sufficient loan documents having a sufficient quality associated therewith are received as part of a loan package that is a suitable candidate for delivery. The various subsets of loan documents for which respective processing supported by various subsystems of the loan processing system 102 may be iteratively performed may be received by the loan processing system 102 in batches over time.

The tracking/loan management subsystem may be further configured to perform processing to evaluate a candidacy of a loan for delivery to one or more intended recipients. The processing for evaluating a candidacy of a loan for delivery may be performed in response to any of variety of human-initiated or automated triggers. The processing to evaluate the candidacy of a loan for delivery may be based on any number of quality parameters indicative of a quality level of the loan package such as, for example, a number or type of missing documents, a number of unresolved exceptions, and so forth. If it is determined, based on the evaluation of the candidacy of the loan for delivery, that the loan is a suitable candidate for delivery, a notification of the loan may be provided as an input to the delivery subsystem.

The delivery subsystem may be configured to perform pre-delivery processing and delivery processing in connection with a loan. Upon receipt of the notification of a loan determined to be a candidate for delivery, the delivery subsystem may be configured to identify one or more target parties as intended recipients of one or more loan documents associated with the loan. Pre-delivery audit processing may be performed with respect to one or more of the identified target parties based on respective profiles associated with the target parties that identify various quality and delivery requirements that must be met prior to delivery. In certain embodiments, the pre-delivery processing must be successful for all identified target parties prior to delivering the loan package. Accordingly, in such embodiments, upon failure of the pre-delivery audit processing with respect to any given target party, pre-delivery audit processing may be halted for remaining target parties. In other embodiments, pre-delivery processing may be performed for all identified target parties and a flag or other identifier may be associated each target party for whom the pre-delivery processing was successful.

The delivery subsystem may be further configured to perform delivery processing in connection with each target party associated with successful pre-delivery processing. The delivery processing may include identifying delivery specifications associated with the target party, formatting of one or more loan documents to be delivered to the target party in accordance with the delivery specifications, and delivering the formatted loan document(s) to the target party.

It should be appreciated that the architecture and associated functionality described above is merely illustrative and that various other architectures, configurations, and implementations are within the scope of the disclosure. For example, a loan processing system according to one or more embodiments of the disclosure may include additional subsystems beyond those described above. Further, in various embodiments, functionality described as being supported by a particular subsystem may be supported, at least in part, in a distributed fashion across multiple subsystems.

Various illustrative aspects of one or more embodiments of the disclosure have been described above. These and other aspects of the disclosure will be described in more detail hereinafter through reference to accompanying drawings.

### Illustrative Architecture

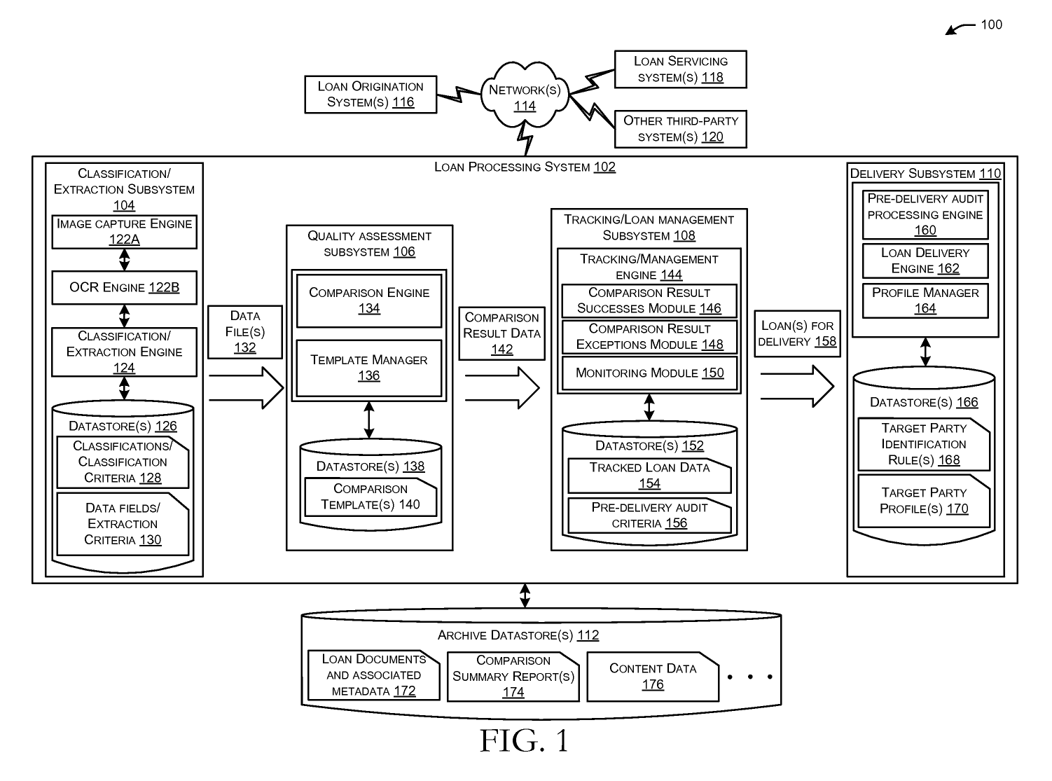

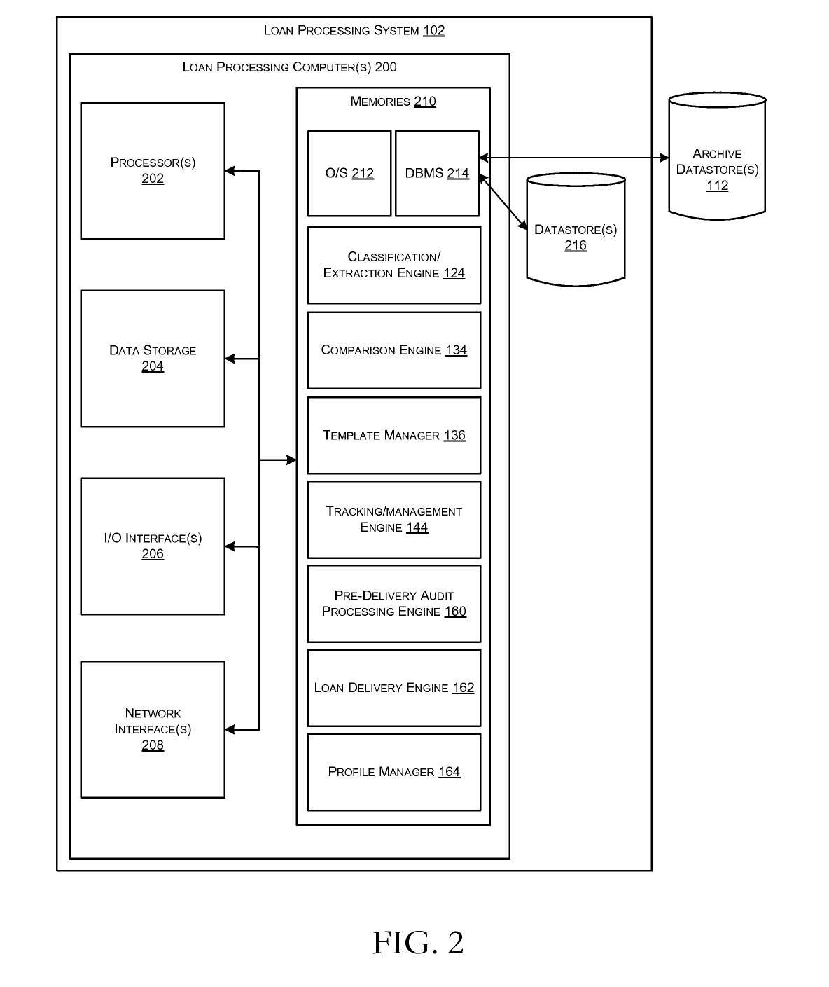

FIG. 1 is a schematic block diagram of an illustrative system architecture 100 for performing various processing associated with a loan package in accordance with one or more embodiments of the disclosure. FIG. 2 is a more detailed schematic block diagram illustrating various hardware and software sub-components of various components of the illustrative architecture of FIG. 1 in accordance with one or more embodiments of the disclosure. FIGS. 1 and 2 will be described hereinafter in conjunction with each other.

The illustrative architecture 100 may include a loan processing system 102. The loan processing system may include one or more of various subsystems 104, 106, 108, 110 that support respective functionality associated with the processing of loans. The subsystems may include a classification/extraction subsystem 104, a quality assessment subsystem 106, a tracking/loan management subsystem 108, and a delivery subsystem 110. The loan processing system may be configured to communicate with one or more other systems via one or more networks 114. For example, the loan processing system may be configured to communicate—via one or more of the network(s) 114—with one or more loan origination systems 116, one or more loan servicing systems 118, and/or one or more other third-party systems 120 such as a third-party system that supports functionality for determining the credit-worthiness of a loan applicant, a third-party system that supports functionality for performing processing to determine compliance with applicable regulatory requirements, and so forth.

The one or more networks 114 may include, but are not limited to, any one or more types of suitable communications networks such as cable networks, wireless networks, cellular networks, or any other private (e.g., frame relay networks) and/or public networks (e.g., the Internet) including networks of any scope of coverage such as metropolitan-area networks (MANs), wide-area networks (WANs), local area networks (LANs), and so forth. Further, the network(s) 114 may include any suitable data transmission medium including, but not limited to, coaxial cable, twisted wire pair, optical fiber, hybrid fiber coaxial (HFC), microwave terrestrial transceivers, radio frequency communications, satellite communications, or combinations thereof.

Each of the subsystems 104, 106, 108, 110 is depicted in FIG. 1 as including a respective group of one or more datastores 126, 138, 152, and 166. Data generated during processing performed by each of the subsystems may be stored in one or more datastores of the respective corresponding group of datastore(s). In addition, data required for processing performed by each subsystem may be retrieved from one or more datastores of the respective corresponding group of datastore(s). Further, the loan processing system 102 (or more specifically the one or more subsystems 104, 106, 108, 110 and associated sub-components thereof) may be configured to access one or more archive datastores 112. A variety of types of data generated during processing performed by any of the subsystems 104, 106, 108, 110 may be stored in the archive datastore(s) 112. For example, as will be described in more detail hereinafter, loan documents and associated metadata 172, comparison summary report data 174, content data 176 associated with various other forms of content (e.g., access logs, audit logs, etc.), and so forth may be stored in one or more of the archive datastore(s) 112. In addition, data may be retrieved from one or more of the archive datastore(s) 112 for manipulation as part of the processing performed by any of the subsystems 104, 106, 108, 110. In certain embodiments, at least a portion of one or more of the subsystem datastore(s) 126, 138, 152, and 166 may be subsumed into the archive datastore(s) 112.

Referring now to FIGS. 1 and 2, in one or more embodiments of the disclosure, the loan processing system 102 may include one or more loan processing computers 200. The loan processing computer(s) 200 may include any suitable processor-driven device(s) such as, for example, a server computer, a desktop computer, a laptop computer, a mainframe computer, and so forth. In certain embodiments, each subsystem (e.g., 104, 106, 108 or 110) of the loan processing system 102 may comprise one or more loan processing computers 200. In certain embodiments, multiple subsystems may include one or more shared loan processing computers 200. In certain embodiments, functionality supported by each of the subsystems of the loan processing system 102 may be performed responsive to execution of computer-executable instructions provided as part of one or more program modules or engines executable on respective loan processing computer(s) 200 forming part of the subsystem. Accordingly, in certain embodiments, a set of loan processing computer(s) 200 associated with a particular subsystem may include only a subset of the program modules or engines depicted as forming part of the illustrative loan processing computer 200 depicted in FIG. 2. In other embodiments, loan processing computers 200 associated with different subsystems may include one or more of the same program modules or engines such as in scenarios in which certain loan processing functionality is distributed across subsystems.

An illustrative loan processing computer 200 may include one or more memory devices 210 (generically referred to herein as memory 210) and one or more processors (processor(s)) 202 configured to execute computer-executable instructions that may be stored in the memory 210. The processor(s) 202 may include any suitable processing unit capable of accepting digital data as input, processing the input data in accordance with stored computer-executable instructions, and generating output data. The processor(s) 202 may be configured to execute the computer-executable instructions to cause or facilitate the performance of various operations. The processor(s) 202 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), and so forth.

The memory 210 may store computer-executable instructions that are loadable and executable by the processor(s) 202 as well as data manipulated and/or generated by the processor(s) 202 during the execution of the computer-executable instructions. The memory 210 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 210 may include any of a variety of different types of memory, such as static random access memory (SRAM), dynamic random access memory (DRAM), unalterable ROM, and/or writeable variants of ROM such as electrically erasable programmable read-only memory (EEPROM), flash memory, and so forth.

The loan processing computer 200 may further include additional data storage 204 such as removable storage and/or non-removable storage including, but not limited to, magnetic storage, optical disk storage, and/or tape storage. Data storage 204 may provide storage of computer-executable instructions and/or other data. The memory 210 and/or the data storage 204, removable and/or non-removable, are examples of computer-readable storage media (CRSM) as that term is used herein.

Referring again to the memory 210, one or more operating systems 212 and one or more database management systems (DBMS) 214 may be loaded into the memory 210 of the loan processing computer 200. The operating system (O/S) 212 may provide an interface between other application software executing on the loan processing computer 200 and hardware resources of the loan processing computer 200. More specifically, the O/S 212 may include a set of computer-executable instructions for managing hardware resources of the loan processing computer 200 and for providing common services to other applications (e.g., managing memory allocation among various applications). The O/S 212 may include any operating system now known or which may be developed in the future including, but not limited to, any server operating system, any desktop or laptop operating system, any mainframe operating system, any mobile operating system, or any other proprietary or freely available operating system.

The DBMS 214 may be loaded into the memory 210 and may support functionality for accessing, retrieving, storing, and/or manipulating data stored in one or more datastores 216 provided as part of the loan processing system 102 (e.g., any of datastores 126, 138, 152, 164 depicted as forming part of respective subsystems of the loan processing system 102). In various embodiments, the one or more of the datastore(s) 216 managed by the DBMS 214 may also be stored in the data storage 204. The DBMS 214 may further support functionality for accessing, retrieving, storing, and/or manipulating data stored in one or more datastores external to the loan processing system 102 such as, for example, the archive datastore(s) 112. The DBMS 214 may use any of a variety of database models (e.g., relational model, object model, etc.) and may support any of a variety of query languages.

The loan processing computer 200 may further include one or more I/O interfaces 206 that facilitate the receipt of information by the loan processing computer 200 that is input via one or more I/O devices as well as the output of information from the loan processing computer 200 to the one or more I/O devices for potential presentation to a user. The I/O devices may include, for example, one or more user interface devices that facilitate interaction between a user and the loan processing computer 200 including, but not limited to, a display, a keypad, a control panel, a pointing device, a touch screen display, a remote control device, a microphone, a speaker, and so forth.

The loan processing computer 200 may further include one or more network interfaces 208 that may facilitate communication between the loan processing computer 200 and other components of the loan processing system 102 as well as communication with external systems via one or more of the network(s) 114. Further, in various embodiments, the network interface(s) 208 may facilitate communication between a loan processing computer 200 associated with any particular subsystem (e.g., the classification/extraction subsystem 104) and a loan processing computer 208 associated with any other subsystem (e.g., the quality assessment subsystem 106).

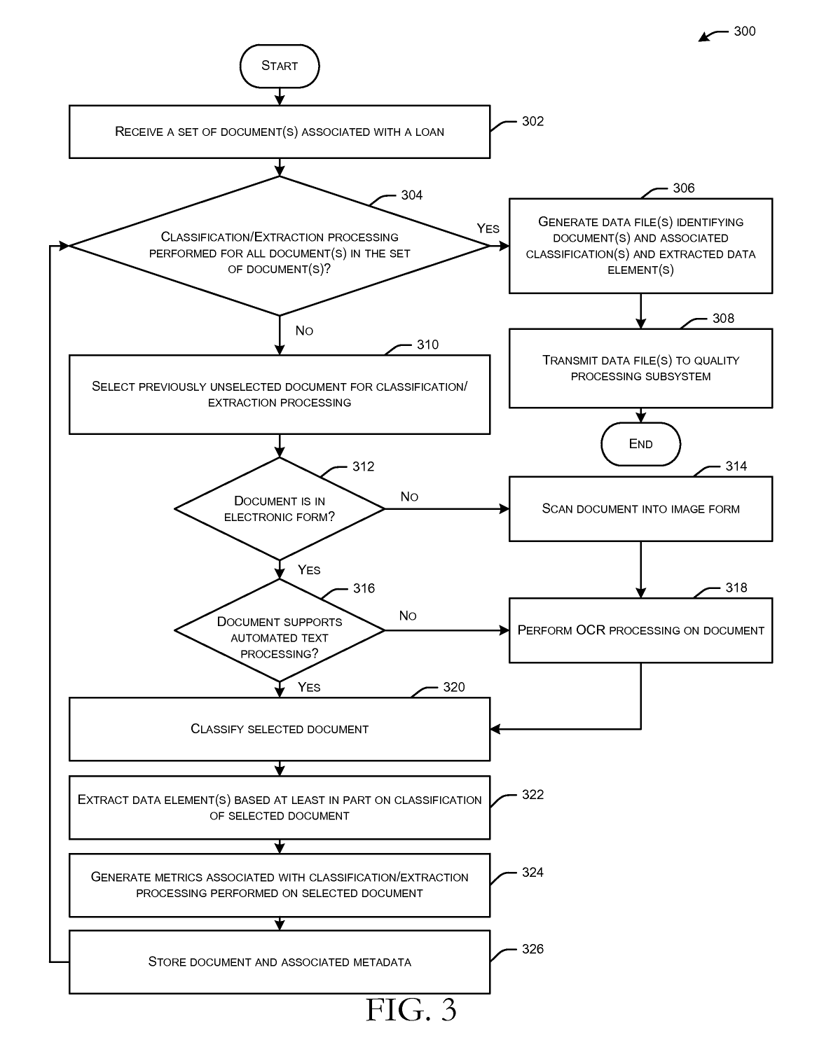

Referring again to the memory 210, various program modules/engines may be loaded therein and may include computer-executable instructions that responsive to execution by the processor(s) 202 causes various respective operations to be performed. The program modules/engines may include a classification/extraction engine 124, a comparison engine 134, a template manager 136, a tracking/management engine 144, a pre-delivery audit processing engine 160, and a loan delivery engine 162. Further, while not depicted in FIG. 2, an image capture engine 122A, a OCR engine 122B, and a profile manager 164 as depicted in FIG. 1 may be loaded into the memory 210 of the loan processing computer 200. Further, as depicted in FIG. 1, the tracking/management engine 144 may further include a comparison result success module 146, a comparison result exceptions module 148, and a monitoring module 150. Respective functionality supported by each of the program modules/engines will be described in more detail through reference to FIG. 1 and the various illustrative methods of FIGS. 3-6.

Those of ordinary skill in the art will appreciate that the illustrative networked architecture 100 depicted in FIG. 1 is provided by way of example only. Numerous other operating environments, system architectures, and device configurations are within the scope of this disclosure. Various embodiments of the disclosure may include fewer or greater numbers of components and/or devices than those depicted in FIG. 1 and may incorporate some or all of the functionality described with respect to the illustrative architecture 100 depicted in FIG. 1, or additional functionality.

Those of ordinary skill in the art will appreciate that any of the components of the architecture 100 may include alternate and/or additional hardware, software or firmware components beyond those described or depicted without departing from the scope of the disclosure. More particularly, it should be appreciated that software, firmware or hardware components depicted as forming part of any of the components of the architecture 100 are merely illustrative and that some components may not be present or additional components may be provided in various embodiments. While various program modules have been depicted and described with respect to various illustrative components of the architecture 100, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, firmware and/or hardware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

### Illustrative Processes

FIG. 3 is a process flow diagram of an illustrative method 300 for performing classification/extraction processing in accordance with one or more embodiments of the disclosure. One or more operations of the method 300 may be performed responsive to execution by the processor(s) 202 of one or more loan processing computers 200 of computer-executable instructions provided as part of the classification/extraction engine 124. Throughout this disclosure, if an operation is described as being performed by a program module/engine, it should be appreciated that the operation may be performed responsive to execution of computer-executable instructions provided as part of the program module/engine.

Referring now to FIG. 3 in conjunction with FIG. 1, at block 302, a set of loan documents associated with a loan may be received for processing to be performed by the classification/extraction subsystem 104. The set of loan documents may be received from a loan origination system 116 or another external system or data source. The set of loan documents may be received together or different subsets of loan documents may be received at different points over a period of time. The illustrative method 300 may be described in the context of classification/extraction processing performed on one subset of loan documents. However, it should be appreciated that the processing may be iteratively performed for each subset of loan documents as they are received until, for example, all required loan documents associated with a loan have been received and processed. Alternatively, the processing could be delayed until a certain threshold number or type loan documents has been received. As will be described in more detail later in this disclosure, the tracking/loan management system 108 may monitor the receipt of new loan documents associated with a loan.

Each loan document in the received set of loan documents may be associated with a respective format. In certain embodiments, various loan documents may be associated with different formats. Illustrative formats may include hardcopy documents, electronic document that support automated text processing, electronic image formatted documents, and so forth.

At block 304, the classification/extraction engine 124 may determine whether classification/extraction processing has been performed for all loan documents in the set of loan documents received at block 302. At a first iteration in the iterative process flow of FIG. 3, it may be determined that classification/extraction processing has not been performed for all received loan documents and the method 300 may proceed to block 310. Processing that follows responsive to a determination that classification/extraction processing has been performed for all received loan documents and that begins at block 306 will be described in more detail later in this disclosure.

At block 310, a previously unselected loan document may be selected for classification/extraction processing. Any suitable mechanism may be employed to determine which loan documents have already been subjected to classification/extraction processing. For example, upon initial receipt of the set of loan documents, the documents may be placed in a suitable data structure (e.g., a list, a linked-list, a queue, an array, etc.) and a pointer may be designated to point to a first loan document. The pointer may then be successively incremented to the next loan document in the data structure upon completion of classification/extraction processing for a selected loan document. It should be appreciated that the above example is merely illustrative and not exhaustive and that any suitable technique may be employed for identifying those loan documents for which classification/extraction processing has been performed.

At block 312, a determination may be made as to whether the selected loan document is in electronic form. If it is determined that the document is not in electronic form, the document may be a hardcopy document. Accordingly, the method 300 may proceed to block 314 where the hardcopy loan document may be scanned into image form. As depicted in FIG. 1, the classification/extraction subsystem 104 may include an image capture engine 122A that may include any suitable combination of hardware and software components for generating an image form of one or more loan documents. For example, the image capture engine 122A may encompass one or more image capture devices 122A that may include a scanning device, a camera device, other image capturing devices capable of being operatively coupled to a loan processing computer 200 of the classification/extraction subsystem 104, and/or a computing device (e.g., a loan processing computer 200) with image capturing functionality. Accordingly, a suitable image capture device 122A of the classification/extraction subsystem 102 may be utilized, in combination with associated software component(s) of the image capture engine 122A, to scan the selected hardcopy document into image form at block 314. The selected document may be scanned into any one of a variety of image file formats including, but not limited to, i) a tagged image file format (TIFF), ii) a joint photographic experts group (JPEG) format, iii) a graphics interchange format (GIF), iv) a bitmap (BMP) format, and so forth.

Documents associated with an image file format generally do not support automated text processing. As used herein, the phrase “automated text processing” may refer to the capability to search and/or extract text characters from a document in an automated manner. Accordingly, at block 318, the OCR engine 122B may include computer-executable instructions that responsive to execution cause optical character recognition (OCR) processing or similar processing to be performed on the scanned document in image form in order to generate an electronic document that supports automated text processing. In certain embodiments, the OCR processing may be performed on an entirety of the document in image form prior to performing any classification or extracting processing. In this manner, an electronic document that is fully capable of supporting automated text processing may be generated such that text of the electronic document can be searched or extracted from any portion of the document.

In other embodiments, the OCR engine 122B may perform selective template-based OCR processing at locations in the document designated by a template. In certain embodiments, and as will be described in more detail hereinafter, the selective template-based OCR processing may be performed in association with the classification processing and/or the extraction processing and may be based on one or more loan document classifications and associated classification criteria 128 and/or extraction criteria 130. As a non-limiting example, classification criteria associated with a loan document classification may include criteria relating to whether one or more locations in a document include one or more character strings, and the OCR engine 122B may perform selective OCR processing to determine whether the classification criteria associated with a loan document classification is satisfied with respect to the selected loan document.

Referring again to block 312, if a determination is made that the selected document is in electronic form, the method 300 may proceed to block 316 where a determination may be made as to whether the selected electronic document already supports automated text processing. If the electronic document does not support automated text processing, the method 300 may again proceed to block 318 where either full or selective template-based OCR processing may be performed by the OCR engine 122B on the electronic document. Illustrative examples of electronic documents that may not support automated texting processing include any of the image file formats discussed above. In addition, a postscript data file (pdf) format may not be text searchable in certain scenarios.

If a determination is made at block 316 that the electronic document does support automated text processing or if OCR processing has been performed on the electronic document at block 318, the method 300 may proceed to block 320 where the selected electronic document that supports automated text processing may be classified. At the stage of the process flow corresponding to block 320, the selected document may either support full searching/extraction capability or selective searching/extraction capability based on whether OCR processing was performed on an entirety of the document or on select portions of the document. Further, the document may have been received in a form that supports automated text processing without requiring OCR processing. For example, if respective positive determinations are made at each of blocks 312 and 316, the selected document may have a file format that supports automated text processing without requiring OCR processing. Illustrative examples of such formats include, but are not limited to, i) a rich text file (rtf) format, ii) a word processing application document format, iii) a markup language format, iv) a postscript data file (pdf) format, or the like. The markup language format may correspond to any suitable markup language such as, for example, HyperText Markup Language (HTML) or any variant thereof, Extensible Markup Language (XML) or any variant thereof, and so forth.

At block 320, the classification/extraction engine 124 may perform classification processing on the selected document. The classification processing may include associating a respective classification with the selected document. The classification/extraction engine 124 may access various loan document classifications and associated classification criteria 128, which may be stored in one or more datastores 126 forming part of the classification/extraction subsystem 104.

Each loan document classification may comprise or otherwise be associated with one or more character strings (e.g., text strings). A loan document may be classified in accordance with a particular loan document classification based on a determination that at least one of the one or more character strings associated with the classification are present in the loan document. Respective one or more classification criteria may be associated with each classification. The classification criteria may include various criteria that the loan document must satisfy in order to be appropriately classified in accordance with the classification to which the classification criteria relate.

The classification criteria may further include various search parameters and/or attributes associated with the character strings that are associated with the classification. The classification/extraction engine 124 may utilize the search parameters and/or attributes as part of the classification processing in order to determine whether a particular loan document may be appropriately classified in accordance with the associated classification.

For example, the classification criteria may include, for each character string associated with a classification, a physical or logical placement of the character string in a loan document, a tag such as an XML tag or other indicator string associated with the character string and one or more optional alternate expressions for the tag, an indication as to whether the character string is optional or required, one or more optional alternate expressions for the character string, and/or a minimum threshold matching confidence level associated with the character string. It should be appreciated that the above examples of classification criteria are merely illustrative and not exhaustive.

In various embodiments, at block 320, the classification/extraction engine 124 may systematically analyze each of the loan document classifications 128 to identify a correspondence between the selected loan document and a particular classification. The order in which classifications are accessed and analyzed may be determined based on one or more prioritization criteria. As a non-limiting example, the one or more prioritization criteria may include criteria associated with a frequency with which loan document types are utilized (e.g., included in loan packages). Loan document classifications may be accessed and analyzed in accordance with a descending frequency of use, such that those classifications that are more common are accessed and analyzed prior to those classifications that are less common. While many loan packages may require a core set of loan document types, the above illustrative prioritization criteria may provide a mechanism by which classifications associated with loan documents that are rarely used are assigned a low priority for selection for classification/extraction processing.

In certain embodiments, the classification processing may halt upon detection of an appropriate classification for association with the selected loan document. In other embodiments, classification processing may be performed in connection with each potential loan document classification, a respective degree of correspondence between each classification and the selected loan document may be determined, and the classification associated with the highest level of correspondence with the loan document may be chosen as the classification according to which the selected loan document is classified.

In certain embodiments, a loan document may be associated with a particular classification even if each character string associated with the classification is not present in the loan document. For example, in certain embodiments, satisfaction of a minimum threshold classification confidence level may be sufficient to associate a particular classification with the selected loan document. In other embodiments, satisfaction of a minimum threshold classification confidence level may be merely a necessary but not sufficient condition for classification and other classification criteria may need to be met in order to associate a classification with the selected document. Accordingly, in certain embodiments, if a respective minimum threshold classification confidence level is not met for any of the candidate loan document classifications, the selected loan document may not be classified. The minimum threshold classification confidence level may relate to any suitable correspondence metric such as, for example, a number of matching data fields, confidence levels associated with individual matching data fields, a percentage of matching data fields, and so forth. It should be appreciated that the above examples of correspondence metrics to which the minimum threshold classification confidence level may relate are merely illustrative and not exhaustive.

Assuming successful classification of the selected loan document at block 320, the method 300 may proceed to block 322 where one or more data elements may be extracted from the selected loan document based on the classification. More specifically, the classification/extraction engine 124 may perform extraction processing to identify and extract one or more data elements from the selected loan document. If the selected document fully supports automated text processing, the entire document may be searched for data elements that may be extracted. For example, if OCR processing is performed on an entirety of the document at block 318 or if the selected document was upon receipt already in a format that supports text processing of the entire document, extraction processing may be performed with respect to the entire document. In contrast, if, for example, selective template-based OCR processing is performed on the document at block 318, the extraction processing may only involve searching those portions of the document subjected to the selective OCR processing to attempt to identify data element(s) for extraction. In certain embodiments, selective template-based OCR processing may be performed as part of the extraction processing performed at block 322.

Information identifying a respective set of one or more data fields 130 associated with each loan document classification 128 and from which corresponding data elements in a loan document are to be extracted may be stored in one or more of the datastore(s) 126. Various respective extraction criteria 130 may also be stored in association with the respective set of data field(s) associated with each loan document classification. The extraction criteria 130 may include criteria that must be satisfied in order to extract one or more data elements from a loan document. For example, the extraction criteria 130 may include a minimum threshold matching confidence level that species a minimum degree of correspondence required between a data field associated with a loan document classification and a data field in a loan document before a data element may be extracted from the data field in the loan document. The extraction criteria 130 may also include, for example, a criterion that specifies a required data field characteristic. As a non-limiting example, the extraction criteria 130 may specify that a particular data field in the loan document must include a particular type of data value (e.g., an alphanumeric value, a numeric value only, a financial value, etc.). As another non-limiting example, the extraction criteria 130 may specify size restrictions on the data value (e.g., a maximum number of characters). As yet another non-limiting example, the extraction criteria 130 may specify that certain data fields may not include certain prohibited characters. It should be appreciate that the above examples are merely illustrative and not exhaustive.

The extraction criteria 130 may also specify various search parameters and/or data field attributes that may assist the classification/extraction engine 124 in locating data fields associated with the classification within the selected document. For example, the search parameters and/or data field attributes may include a physical or logical position of a data field in a loan document, a text string associated with a data field such as a markup language tag (e.g., an XML tag), a character string graphically positioned in a predetermined position in relation to the data field, and so forth. It should be appreciated that the above examples of search parameters and/or data field attributes that may be specified by the extraction criteria 130 are merely illustrative and not exhaustive.

At block 322, as part of the extraction processing, the classification/extraction engine 124 may attempt to locate each of the data field(s) associated with the classification according to which the selected loan document was classified at block 320, and may extract data element(s) corresponding to those data field(s) that are determined to be present in the loan document. As previously noted, the determination that a data field is present in a loan document may be made with respect to a minimum threshold matching confidence level associated with the data field.

At block 324, one or more metrics associated with the classification processing performed at block 320 and/or the extraction processing performed at block 322 may be generated. It should be appreciated that the classification/extraction processing metric(s) may be generated in any suitable manner such as concurrently with the classification and/or extraction processing or subsequent to completion of the classification and extraction processing. The metrics may include, for example, a classification confidence metric indicative of a degree of correspondence between the classification and the selected loan document, a metric indicative of the number of data elements extracted from the selected loan document, a percent of data fields associated with the classification for which corresponding data elements were extracted from the selected loan document, individual field extraction confidence metrics indicative of a degree of correspondence between a particular data field associated with the classification and a corresponding data field of the selected loan document, an overall field extraction confidence metric indicative of a degree of correspondence between data fields of the selected loan document from which data elements were extracted and corresponding data fields associated with the classification, and so forth. It should be appreciated that the above examples of metrics that may be generated are merely illustrative and not exhaustive.

At block 326, the selected loan document and associated metadata may be stored in association in, for example, the one or more of the archive datastore(s) 112. The associated metadata may include, for example, the classification associated with the selected document, the extracted data element(s), any generated metric(s), and so forth.

Upon storing the selected loan document and associated metadata, the method may proceed again to block 304 where a determination may be made as to whether classification and extraction processing has been performed for all documents in the received set of documents. If it is determined that there remains at least one document for which classification and/or extraction processing has not been performed, the method may again proceed to block 310 and a previously unselected document may be selected for classification and extraction processing. The iterative process described above may be performed for each document in the received set of documents.

If a determination is made at block 304 that classification and extraction processing has been performed for all documents in the received set of documents, the method 300 may proceed to block 306 where one or more data files 132 may be generated that identify the set of documents, their associated classification, data elements extracted from the documents as a result of the extraction processing, and potentially any associated metrics that may have been generated. In one or more embodiments, the data file(s) 132 may take the form of a metadata file. The data file(s) 132 may include the above-mentioned information directly in the file or may include a reference or link to the data 172 stored, for example, in the archive datastore(s) 112. At block 308, the classification/extraction subsystem (or more specifically the classification/extraction engine 124) may communicate the data file(s) 132 to the quality processing subsystem.

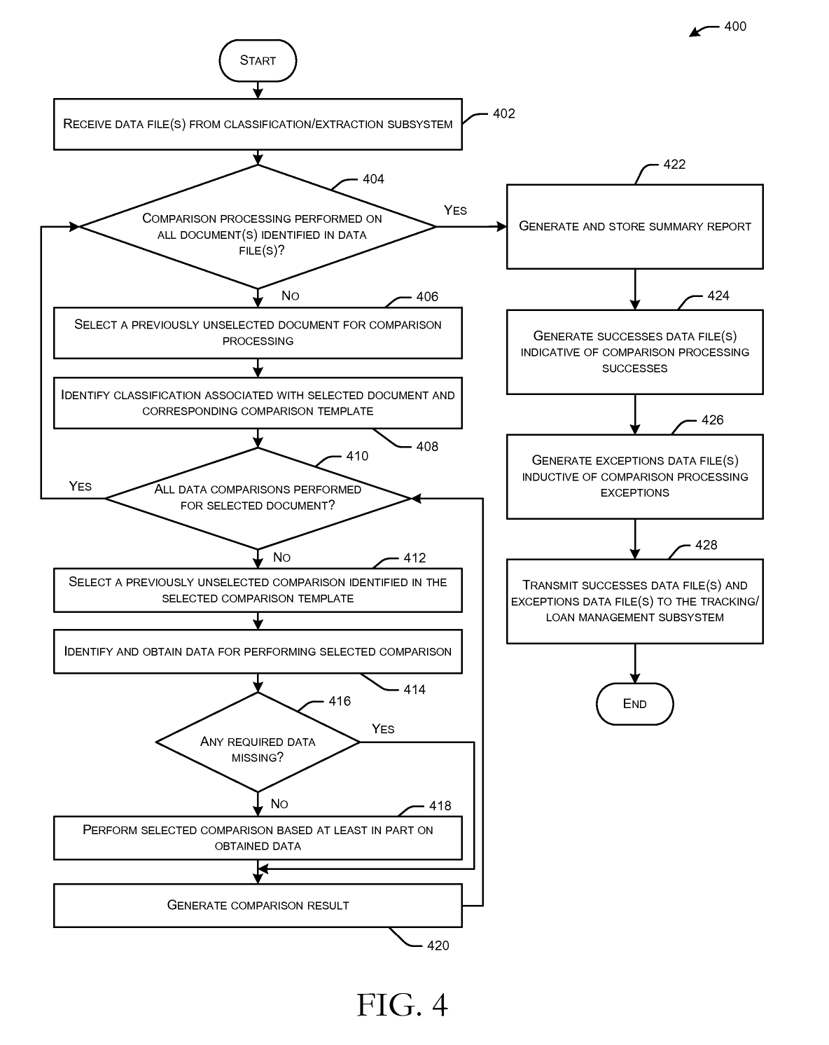

FIG. 4 is a process flow diagram of an illustrative method for performing comparison processing in accordance with one or more embodiments of the disclosure. One or more operations of the method 400 may be performed responsive to execution by the processor(s) 202 of one or more loan processing computers 200 of computer-executable instructions provided as part of the comparison engine 134 and/or the template manager 136.

At block 402, the data file(s) 132 generated by the classification/extraction engine 124 may be received by the quality processing subsystem 106. Comparison processing may then be performed by the comparison engine 134 iteratively for each document in the set of documents identified in the data file(s) 132 at blocks 404-420.

At block 404, the comparison engine 134 may make a determination as to whether comparison processing has been performed for all documents in the set of documents identified in the data files(s) 132. If it is determined that comparison processing has been performed for all documents in the set of documents identified in the data file(s) 132, the method 400 may proceed to block 422. If, however, it is determined that comparison processing has not been performed for at least one document in the set of documents, the method 400 may proceed to block 406 where the comparison engine 134 may select a previously unselected document for performing comparison processing. As described previously with respect to classification/extraction processing, any suitable mechanism may be employed to determine which loan documents have already been subjected to comparison processing. For example, upon identification of the set of loan documents from the data file(s) 132, the documents may be placed in a suitable data structure and a pointer may be designated to point to a first loan document. The pointer may then be successively incremented to the next loan document in the data structure upon completion of the comparison processing for a selected loan document.

At block 408, the template manager 136 may identify a classification associated with the selected document and a comparison template 140 that corresponds to the identified classification. The comparison template 140 may be retrieved by the template manager 136 from one or more of the datastore(s) 138 storing a collection of comparison templates 140. The comparison template 140 may specify a set of one or more comparisons to be performed between data field(s) of the selected document and corresponding data field(s) from secondary source data. The secondary source data may be received from any suitable secondary data source(s) such as, for example, the loan servicing system(s) 118, other third-party system(s) 120, and so forth. Upon identification of the comparison template 140, the set of comparison(s) identified therein may be performed iteratively at blocks 410-420.

While embodiments of the disclosure may be described in the context of comparison processing involving comparisons between data fields of a selected document and corresponding data fields of secondary source data, it should be appreciated that numerous other comparisons may be performed as well as part of the comparison processing. For example, one or more data fields in a first loan document received by the loan processing system 102 may be compared to one or more data fields in a second loan document received by the loan processing system 102. It should be appreciated that the above example is merely illustrative and not exhaustive.

Each comparison in the comparison template 140 identifies one or more data fields in the selected loan document that are to be compared to one or more fields in the secondary source data. At this stage in the process flow, the secondary source data may have already been received by the quality processing subsystem 106 and may be stored, for example, in one or more of the datastore(s) 138. In certain embodiments, the secondary source data may be “pushed” by an external system to the quality processing subsystem 106. In other embodiments, the secondary source data may be “pulled” from the external system by the quality processing subsystem 106. In still other embodiments, the quality processing subsystem 106 may obtain required secondary source data dynamically in a “just-in-time” manner based on a particular comparison that is being performed. It should be appreciated that the terms “data field” and “data value” may be used interchangeably herein.

At block 410, a determination may be made as to whether all data comparisons identified by the comparison template 140 have been performed for the selected document. At a first stage in the iterative processing before any data comparisons have been made, a determination may be made that all data comparisons have not been performed for the selected document, at which point, the method may proceed to block 412 where a previously unselected comparison may be selected from the comparison template. As similar described earlier with respect to classification/extraction processing and comparison processing for the set of documents identified in the data file(s) 132, any suitable methodology may be employed for identifying comparisons that have not previously been selected. For example, the comparisons may be ordered in a data structure and a pointer may be incrementally updated to point to the next comparison to be performed.

At block 414, required secondary source data for performing the selected comparison may be retrieved from one or more of the local datastore(s) 138 and/or from one or more external systems. At block 416, a determination may be made as to whether any required secondary source data is missing. If it is determined that secondary source data for performing the comparison is not available, the comparison may not be able to be performed, and the method may skip block 418 and proceed to block 420.

If, on the other hand, a determination is made that no required secondary source data is missing, the method may proceed to block 418 where the selected comparison may be performed. For certain comparisons, one or more data fields in the selected document may be directly compared to one or more data fields in the secondary source data. In other embodiments, a value may be derived from one or more data fields in the secondary source data, and one or more data fields in the selected document may be compared to the derived value. In yet other embodiments, a value may be derived from one or more data fields in the selected document and the derived value may be compared to one or more data fields in the secondary source data. In other embodiments, a value derived from data values associated with one or more data fields in the selected document may be compared to a data value derived from one or more data values in the secondary source data. Further, each comparison may specify a desired relationship that should exist between one or more data fields in the selected document (or a value derived therefrom) and one or more data fields in the secondary source data (or a value derived therefrom). Various relationships may be specified such as, for example, an equivalency relationship (e.g., an exact correspondence between data fields), an inclusion relationship (e.g., the content of a data field in the document should be included in one or more data fields in the secondary source data or vice versa), an exclusion relationship (e.g., the content of a data field in the document should not be included in one or more data fields in the secondary source data or vice versa), an inequality relationship (e.g., a data value associated with a data field in the document should be greater than a data value associated with a corresponding data field in the secondary source data), and so forth. It should be appreciated that the above examples of types of desired relationships that may be specified by a comparison are merely illustrative and not exhaustive and that numerous other examples are within the scope of this disclosure.

In addition, a comparison may indicate a tolerance level that is permitted. The tolerance level may be specified in accordance with any suitable parameter including, but not limited to, i) minimum comparison matching confidence level, ii) an absolute number of matching characters, iii) a percentage of total characters that are matching, iv) a numerical threshold such as a maximum difference, variance, or other statistical measure.

At block 420, a comparison result may be generated based on the comparison performed at block 418 or a determination at block 416 that not all required data was able to be obtained. The comparison result may be designated as a “success” if the desired relationship is established by the comparison within an acceptable tolerance. In contrast, if the comparison could not be performed due to missing secondary source data or the comparison did not establish the desired relationship (or failed to establish the desired relationship within the acceptable tolerance level), the comparison result may be designated as an “exception.”

The method 400 may then proceed again to block 410 where a determination may again be made as to whether all comparisons identified in the comparison template 140 have been performed (or have been attempted). The operations of blocks 410-420 may be performed iteratively until all data comparisons identified in the comparison template 140 are performed. If it is determined that all data comparisons have been performed, the method 400 may proceed to block 404 where a determination may again be made as to whether comparison processing has been performed on all documents in the set of loan documents identified in the data file(s) 132. If it is determined that there remain loan document(s) for which comparison processing has not been performed, the method 400 may again proceed to block 406 where a previously unselected loan document may be selected for comparison processing. The process flow may then continue iteratively from block 406 until comparison processing is performed for each loan document.

On the other hand, if it is determined that comparison processing has been performed for all loan documents in the set of loan documents, the method may proceed to block 422 where a summary report 174 may be generated and stored in, for example, one or more of the datastore(s) 138 and/or one or more of the archive datastore(s) 112. The summary report may identify the comparison successes and exceptions for the subset of loan documents identified in the data file(s) 132 or for all documents associated with the loan that have been received to date. In certain embodiments, additional documents that are associated with the loan may be received by the quality processing subsystem 106 subsequent to receipt of the data file(s) 132.

At block 424, the comparison engine 134 may generate one or more data file(s) indicating each comparison designated as a success for the subset of loan documents identified in the data file(s) 132 received from the classification/extraction subsystem 104 or for all loan documents associated with the loan that have been received thus far (which may represent a more cumulative collection of loan documents associated with the loan). In addition, At block 426, the comparison engine 134 may generate one or more data file(s) indicating each comparison designated as an exception for the subset of loan documents identified in the data file(s) 132 received from the classification/extraction subsystem 104 or for all loan documents associated with the loan that have been received thus far. At block 428, the quality processing subsystem 106 may communicate the successes data file(s) and the exceptions data file(s) as comparison result data 142 to the tracking/loan management subsystem 108.

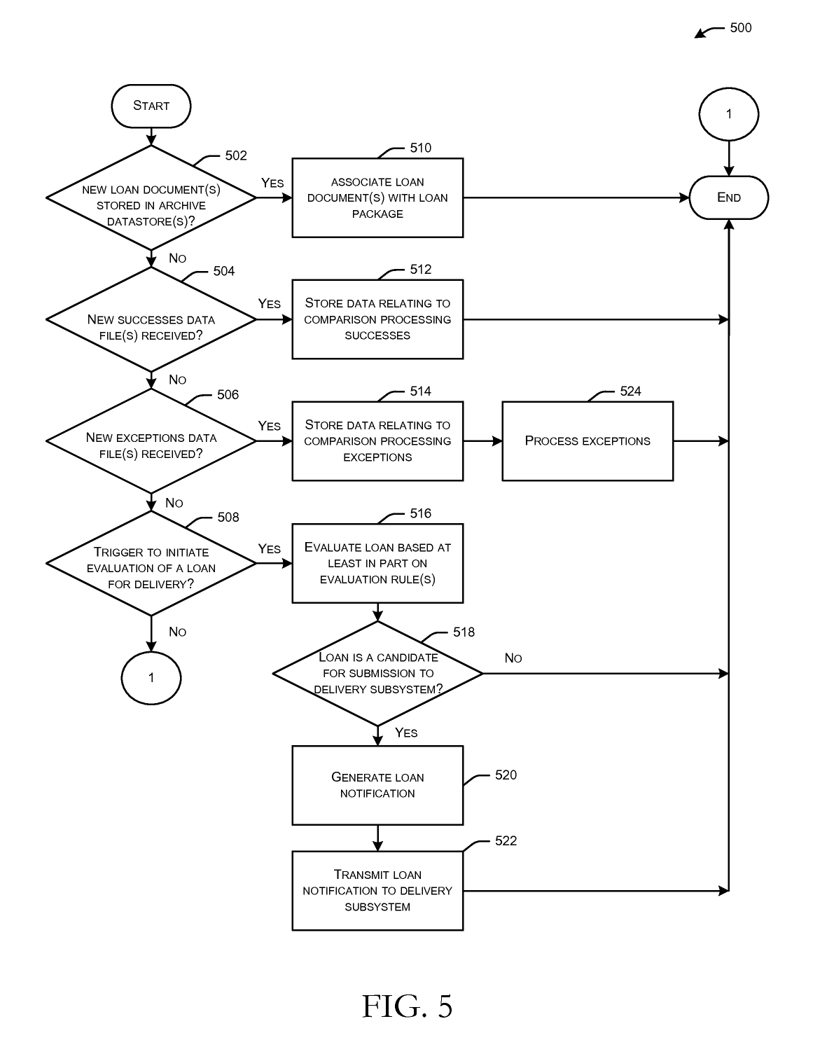

FIG. 5 is a process flow diagram of an illustrative method 500 for performing loan tracking and management processing in accordance with one or more embodiments of the disclosure. One or more operations of the method 500 may be performed responsive to execution by the processor(s) 202 of one or more loan processing computers 200 of computer-executable instructions provided as part of the tracking/management engine 144, or more specifically, the comparison result successes module 146, the comparison result exceptions module 148, and/or the monitoring module 150.

The processing performed by the tracking/loan management system 108 may be event-driven in that certain types of processing may be performed responsive to certain types of triggers. For example, blocks 502, 504, 506, and 508 represent various illustrative triggering events that may trigger corresponding processing to be performed. It should be appreciated that the depicted sequential nature of the determinations of blocks 502, 504, 506, 508 is non-limiting and that any of the associated triggering events may occur in any order and the occurrence of any one event may have no bearing on whether another event may occur.

At block 502, a first illustrative type of triggering event is depicted. In particular, at block 502, the tracking/management engine 142, or more specifically, the monitoring module 150, may determine whether any new loan document(s) associated with the loan have been stored, for example, in one or more of the datastore(s) 112. If it is determined that new loan document(s) have been stored, the tracking/management engine 142 may associate the new loan documents with an existing loan package. For example, in one or more embodiments, the tracking/management engine 142 may store or direct the storage of respective identifications of the new loan document(s) in association with an identifier of the loan. The association of the new loan document(s) with an identifier associated with a loan package may be stored in one or more of the datastore(s) 152 as a loan record associated with a loan. The loan record may form at least part of the tracked loan data 154. In various embodiments, the monitoring module 150 may be configured to monitor other content associated with a loan beyond data associated with loan documents. For example, the document monitoring module may be configured to monitor log or event data, report data, etc. that may be stored in one or more of the datastore(s) 112.

At block 504, a second illustrative type of triggering event is depicted. In particular, at block 504, the tracking/management engine 142, or more specifically, the comparison result successes module 146 may determine whether one or more new successes data file(s) have been received from the quality assessment subsystem 104 that are indicative of comparison result successes associated with comparison processing performed in connection with one or more loan documents. If a positive determination is made at block 504, the comparison result successes module 146 (or one or more other components of the tracking/management engine 142) may store or direct the storage of the data relating to the comparison processing result successes in an appropriate loan record in one or more of the datastore(s) 152.

At block 506, a third illustrative type of triggering event is depicted. In particular, at block 506, the tracking/management engine 142, or more specifically, the comparison result exceptions module 148 may determine whether one or more new exceptions data file(s) have been received from the quality assessment subsystem 104 that are indicative of comparison result exceptions associated with comparison processing performed in connection with one or more loan documents. If a positive determination is made at block 506, the comparison result exceptions module 148 (or one or more other components of the tracking/management engine 142) may store or direct the storage of the data relating to the comparison processing result exceptions in an appropriate loan record in one or more of the datastore(s) 152.

Upon storage of the data relating to the exceptions results at block 514, the method 500 may proceed to block 524 where exceptions handling processing may be initiated. In certain embodiments, at least a portion of the exceptions handling processing may be automated. In other embodiments, the exceptions handling processing may be primarily a manually-driven process that may be facilitated by one or more user interfaces and/or software tools that may be provided by the tracking/loan management subsystem 108. As exceptions are handled (e.g., resolved or corrected) by the exceptions handling processing, associated metadata such as comparison processing results, quality metrics, and so forth stored in one or more of the archive datastore(s) 112 and/or in one or more of the datastore(s) 152 may be updated accordingly.

At block 508, a fourth illustrative type of triggering event is depicted. In particular, at block 508, the tracking/management engine 142 may determine whether a trigger has been received to initiate evaluation of a candidacy of a loan for delivery to the delivery subsystem 110. The trigger may be any of a wide variety of triggers such as, for example, i) a time-based trigger (e.g., periodic evaluation of the candidacy of a loan for delivery), ii) a manually-initiated trigger submitted, for example, via a user interface; or iii) an automated request received, for example, from the delivery subsystem 110 or another system or subsystem distinct from the tracking/loan management subsystem 108.

If it is determined at block 508 that a trigger to initiate evaluation of a candidacy of loan for delivery has been received, the method 500 may proceed to block 516 where the loan may be evaluated based on one or more evaluation rules. The evaluation rule(s) may relate to any number of attributes associated with the loan such as, for example, a number of missing loan documents, a number of outstanding exceptions, other metrics indicative of a “quality” of the loan that may have been generated during various prior processing and stored as metadata associated with the loan, and so forth. The set of evaluation rule(s) may be stored in one or more of the datastore(s) 152 and may be dynamically updated based on, for example, changing attributes associated with the loan. In other embodiments, the evaluation rule(s) may form part of the computer-executable instructions of the tracking/management engine 142.

Upon evaluation, based on the evaluation rule(s), of various data, attributes, etc. associated with the loan, a determination may be made at block 518 as to whether the loan is a candidate for submission to the delivery subsystem 110. If it is determined that the loan is a candidate for submission to the delivery subsystem 110, a loan notification 158 identifying the loan may be generated at block 520 and communicated to the delivery subsystem 110 at block 522. The loan notification 158 communication may take on any suitable form including, but not limited to, an asynchronous transmission (e.g., a batch file or message posted to a message queue) or a synchronous transmission (e.g., invocation of an API such as a Web service or response to a request that triggered the processing of at blocks 516-522). On the other hand, if it is determined that the loan is not a candidate for delivery, the method 500 may end. At some later time, another trigger to initiate evaluation of the candidacy of the loan for delivery may be received. A loan previously determined not to be a suitable candidate may, in various embodiments, now be determined to be a suitable candidate based on, for example, additional exceptions that have been resolved, missing loan documents that have been received, and so forth.

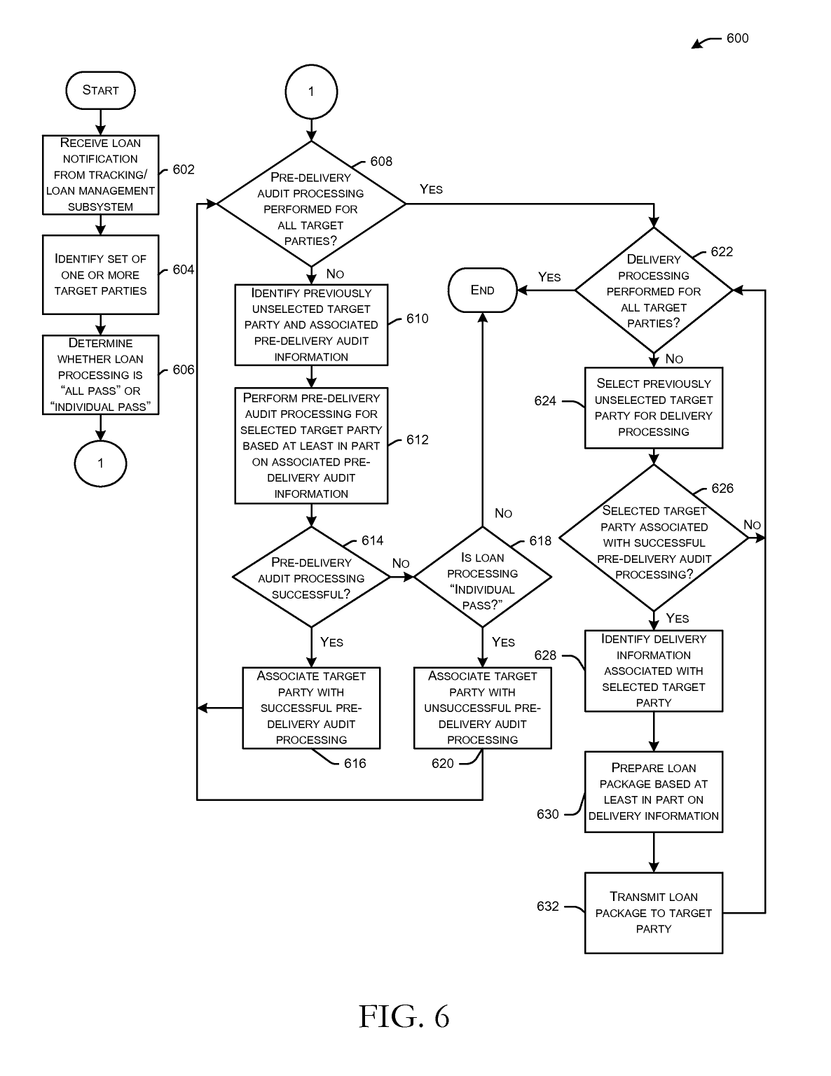

FIG. 6 is a process flow diagram of an illustrative method for performing pre-delivery audit processing and/or delivery processing in accordance with one or more embodiments of the disclosure. One or more operations of the method 600 may be performed responsive to execution by the processor(s) 202 of one or more loan processing computers 200 of computer-executable instructions provided as part of the pre-delivery audit processing engine 160, the loan delivery engine 162, and/or the profile manager 164. While the method 600 may be described illustratively in the context of processing performed in connection with one loan for ease of explanation, it should be appreciated that processing performed by the delivery subsystem 110 may be performed on a set or pool of multiple loans.

At block 602, a notification of a loan determined to be a candidate for delivery to one or more target parties may be received by the delivery subsystem 110 from the tracking/loan management subsystem 108. The loan notification may have been “pushed” by the tracking/loan management subsystem 108 to the delivery subsystem 110 or “pulled” by the delivery subsystem 110 from the tracking/loan management subsystem 108.

At block 604, one or more target parties may be identified based on one or more attributes associated with the loan and one or more target party identification rules 168. In certain embodiments, the profile manager 164 may include computer-executable instructions for analyzing the loan attributes in relation to the rule(s) 168 to identify the one or more target parties. While the target party identification rules 168 are depicted in FIG. 1 as being stored in the datastore(s) 166, it should be appreciated that in certain embodiments the rule(s) 168 may form part of the computer-executable instructions provided as part of the profile manager 164 or one or more other program modules (e.g., may be hardcoded in software). The loan attribute(s) may be identified from the notification received at block 602 or from data associated with the loan and stored in one or more of the archive datastore(s) 112 and/or in one or more of the respective datastore(s) associated with various subsystems of the loan processing system 102. In certain embodiments, all loan documents of the loan may be intended for delivery to a single target party while in other embodiments various subsets of loan documents may be intended for different target parties.

At block 606, a determination may be made with respect to scenarios in which multiple target parties are identified. More specifically, a determination may be made at block 606 as to whether respective loan document(s) may be delivered to one or more target parties if pre-audit delivery processing (which will be described in more detail hereinafter) fails with respect to another target has failed (hereinafter referred to as “individual pass”) or whether failure of pre-delivery audit processing with respect to any one target party prohibits delivery of loan documents to any other target party (hereinafter referred to as “all pass”). The determination at block 606 may be made concurrently with the identification of one or more target parties.

The operations of blocks 608-620 may form part of iterative pre-delivery audit processing that may be performed, for example, responsive to execution of computer-executable instructions provided as part of the pre-delivery audit processing engine 160 and/or the profile manager 164. In one or more embodiments, identifiers associated with the target parties may be organized into a suitable data structure (e.g., a list, a linked-list, a queue, an array, etc.) and a pointer may be designated to point to a first target party identifier. The pointer may then be successively incremented to each successive target party identifier in the data structure upon completion of pre-delivery audit processing in connection with a previous target party. It should be appreciated that the above example is merely illustrative and not exhaustive and that any suitable technique may be employed for identifying those target parties for whom pre-delivery audit processing has been performed.

At block 608, a determination may be made as to whether pre-delivery audit processing has been performed for all identified target parties. At a first stage in the iterative pre-delivery audit processing, a determination may be made that pre-delivery audit processing has not been performed for all target parties. At block 610, a previously unselected target party may be identified. Further, pre-delivery audit information associated with the selected target party may be identified as well.

A collection of target party profiles 170 may be stored in one or more of the datastore(s) 166. Each target party profile may be associated with a respective target party and may specify various quality and delivery requirements associated with the target party. The target party profile may include pre-delivery audit information and delivery information. The pre-delivery audit information may be utilized as part of the pre-delivery audit processing and the delivery information may be used as part of the delivery processing.

The pre-delivery audit information may include, but is not limited to, an identification of loan documents to be delivered to the target party, minimum quality thresholds identified on a per loan document basis or in the aggregate and potentially forming part of a quality rating or score that may be further based on any number of other quality metrics, and so forth. The delivery information may include, but is not limited to, i) an identification of loan documents to be delivered to the target party, ii) respective formatting requirements for each loan document, iii) one or more communication protocols to be used for delivering a respective one or more loan documents, and/or iv) one or more location identifiers associated with a respective one or more of the loan documents, where each location identifier may include one of: a physical address for hardcopy delivery or a network address for electronic delivery to the target party.

At block 612, the pre-delivery audit processing module 160 may perform pre-delivery audit processing for the selected target party based on the identified pre-delivery audit information associated with the selected target party. The pre-delivery audit processing may involve an assessment of multiple loan documents and associated metrics or other metadata with respect to the pre-delivery audit information associated with the selected target party.

At block 614, a determination may be made as to whether the pre-delivery audit processing was successful. The pre-delivery audit processing may generate a binary result that indicates that the processing either passed or failed. If it is determined at block 614 that the processing failed, a determination may be made at block 618 as to whether the processing of the loan was determined to be “individual pass” or “all pass.” If it is determined that the loan processing is not “individual pass” (i.e., that the processing is “all pass”), the pre-delivery audit processing may end and the delivery processing may not be performed because the loan processing is “all pass” and pre-delivery audit processing failed for at least one target party.

On the other hand, if it is determined at block 618 that the loan processing is “individual pass,” failure of the pre-delivery audit processing with respect to the current target party may not prohibit delivery of loan documents to other target parties for whom the pre-delivery audit processing is successful. Accordingly, if it is determined that the loan processing is “individual pass,” the method 600 may proceed to block 620 where an indicator that pre-delivery audit processing has failed with respect to the current target party may be associated with the target party and the method may again proceed to block 608 where a determination may again be made as to whether pre-delivery audit processing has been performed for all identified target parties. Because at this stage in the process flow it has been determined that the loan processing is “individual pass,” the pre-delivery audit processing may continue to be performed on all identified target parties.

Further, if it is determined at block 614 that the pre-delivery audit processing was successful for the current party, the method 600 may proceed to block 616 where an indicator that pre-delivery audit processing was successful with respect to the current target party may be associated with the current target party and the method may again proceed to block 608. As long as pre-delivery audit processing is successful for each selected target party, a determination may not be made as to whether the loan processing is “individual pass” or “all pass.”

It should be appreciated that a positive determination that pre-delivery audit processing has been performed for all target parties may only be made at block 608 in those scenarios where the pre-delivery audit processing was successful for each selected target party or in scenarios in which the loan processing is determined to be “individual pass.” Upon a positive determination at block 608, the method may proceed to block 622 where a determination may be made as to whether delivery processing has been performed for all target parties. If it is determined that delivery processing has been performed for all target parties, the method 600 may end.

On the other hand, if it is determined that delivery processing has not been performed for at least one target party, the method may proceed to block 624 where a previously unselected target party may be selected for delivery processing. At block 626, a determination may be made as to whether pre-delivery audit processing was successful for the selected target party. If it was not, the method may again proceed to block 622 and the process may continue iteratively until delivery processing has been performed for all target parties. In accordance with one or more embodiments of the disclosure, identifiers associated with the target parties may be organized into a suitable data structure and a pointer may be used to identify the next target party for whom delivery processing is to be performed. The pointer may be successively incremented to a next target party upon completion of delivery processing in connection with a current target party.

If the selected target party is determined to be associated with successful pre-delivery audit processing at block 626, the method 600 may proceed to block 628 where the delivery information associated with the selected target party may be identified. The delivery information may have previously been identified at block 610. At block 630, the loan package may be prepared for delivery based on the delivery information. At block 632, the loan package may be transmitted to the selected target party. It should be noted that hardcopy loan documents may be generated from corresponding electronic loan documents, and the hardcopy documents may be transmitted to a physical address. In other embodiments, electronic loan documents may be transmitted to a network address. In certain other embodiments, a combination of two transmission modes may be employed. From block 632, the method 600 may again proceed to block 622 and the process may continue iteratively until delivery processing has been performed for all target parties.

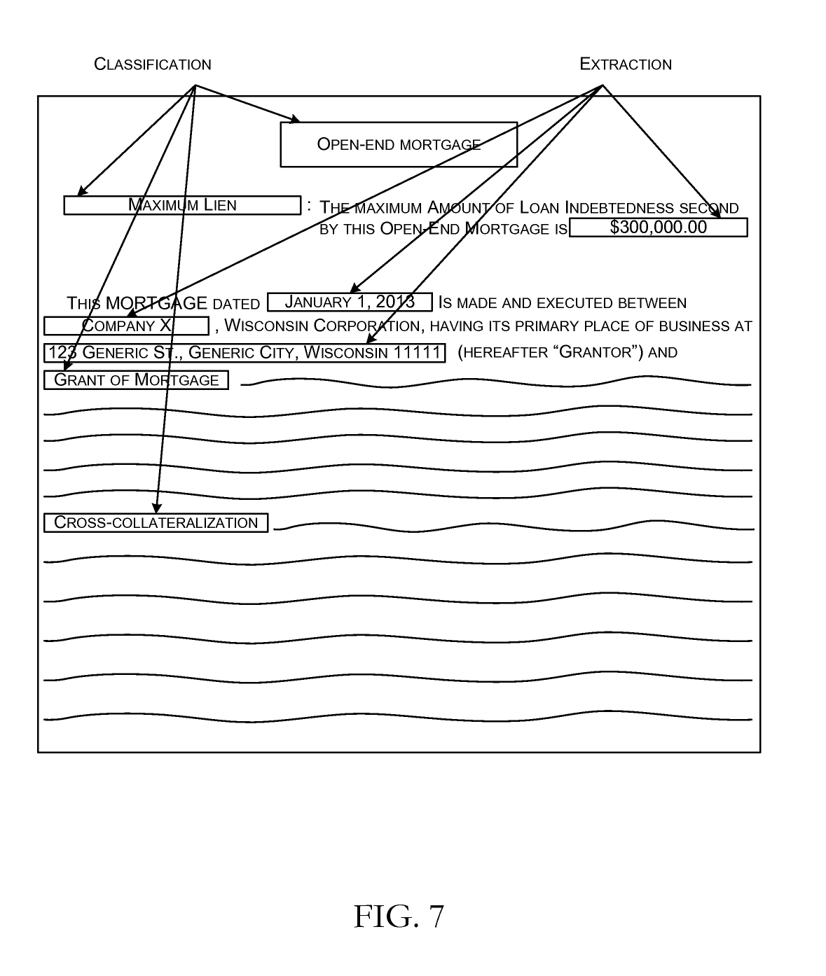

FIG. 7 is a schematic depiction of illustrative data elements that may be identified in an illustrative loan document as part of classification/extraction processing performed in accordance with one or more embodiments of the disclosure.

As shown in FIG. 7, various character strings may be identified in the illustrative loan document and may compared to character strings associated with one or more loan document classifications to determine one or more classifications to associate with the loan document. Further, various data elements corresponding to data fields associated with the classification of the loan document may be extracted from the document. While the classification and extraction fields are depicted in FIG. 7 as being distinct, in one or more embodiments, one or more of the classification and extraction fields may overlap. As a non-limiting example, a field used to classify a document may include an indicator portion and a variable value portion. The variable value portion may correspond to an extracted data element.

The operations described and depicted with respect to the illustrative processing flows of FIGS. 3-6 may be carried out or performed in any suitable order as desired in various embodiments of the disclosure. Additionally, in certain embodiments, at least a portion of the operations may be carried out in parallel. Furthermore, in certain embodiments, less, more, or different operations than those depicted in FIGS. 3-6 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, although specific example embodiments have been presented, it should be appreciated that numerous other examples are within the scope of this disclosure.

Additional types of CRSM that may be present in association with any of the components described herein (e.g., any of the components of the networked architecture 100) may include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, solid-state memory devices, or any other medium. Combinations of any of the above are also included within the scope of CRSM.

Alternatively, computer-readable communication media may include computer-readable instructions, program modules, or other data transmitted within a data signal, such as a carrier wave, or other transmission. Examples of computer-readable communication media, whether modulated using a carrier or not, include, but are not limited to, signals that a computer system or machine hosting or running a computer program can be configured to access, including signals downloaded through the Internet or other networks. For example, the distribution of software may be an Internet download. However, as used herein, CRSM does not include computer-readable communication media.

Although embodiments have been described in language specific to structural features and/or methodological acts, it is to be understood that the disclosure is not necessarily limited to the specific features or acts described. Rather, the specific features and acts are disclosed as illustrative forms of embodiments of the disclosure. Conditional language such as, for example, “can,” “could,” “might,” or “may,” unless specifically stated otherwise, or unless otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

That which is claimed is:

1. A system, comprising:
at least one processor; and
at least one memory storing computer-executable instructions,
wherein the at least one processor is configured to access the at least one memory and to execute the computer-executable instructions to:
identify a set of one or more electronic loan documents;
perform classification processing to determine a respective classification for each electronic loan document in the set of one or more electronic loan documents;
perform extraction processing to extract a set of one or more data elements, wherein each data element in the set of one or more data elements is extracted from a respective corresponding electronic loan document based at least in part on the respective classification;
identify a set of one or more textual comparisons, wherein each textual comparison in the set of one or more textual comparisons specifies a comparison to be performed between a respective at least one data element in the set of one or more data elements and a respective at least one data element from an external data source;
perform comparison processing based at least in part on the set of one or more textual comparisons to generate a set of one or more comparison results; and
determine, based at least in part on at least a portion of the set of one or more comparison results, whether the loan is a candidate for delivery to one or more target parties.

2. The system of claim 1, wherein the at least one processor is further configured to execute the computer-executable instructions to:
receive a set of one or more documents; and
convert the set of one or more documents to the set of one or more electronic documents.

3. The system of claim 2, wherein, to convert the set of one or more loan documents to the set of one or more electronic loan documents, the at least one processor is configured to execute the computer-executable instructions to:
identify a subset of one or more loan documents from the set of one or more loan documents, wherein each loan document in the subset is not in an electronic form that supports automated text processing; and
convert each loan document in the subset into an electronic loan document that supports automated texting processing.

4. The system of claim 3, wherein, to convert each loan document in the subset into an electronic loan document that supports automated text processing, the at least one processor is configured to execute the computer-executable instructions to:
perform, for each loan document in the subset, respective optical character recognition processing on one of: i) an image form of the loan document or ii) the loan document.

5. The system of claim 4, wherein, to perform the respective optical character recognition processing, the at least one processor is configured to execute the computer-executable instructions to:
i) perform the respective optical character recognition processing on an entirety of one of: i) the image form of the loan document or ii) the loan document, or
ii) perform the respective optical character recognition processing on a specified portion of one of: i) the image form of the loan document or ii) the loan document.

6. The system of claim 1, wherein each electronic loan document in the set of one or more electronic loan documents is associated with a respective electronic form that supports automated text processing.

7. The system of claim 6, wherein the respective electronic form comprises one of:
i) a tagged image file format (TIFF),
ii) a joint photographic experts group (JPEG) format,
iii) a graphics interchange format (GIF),
iv) a bitmap (BMP) format,
v) a rich text file (rtf) format,
vi) a word processing application document format,
vii) a markup language, or
iv) a postscript data file (pdf) format.

8. The system of claim 1, wherein the at least one processor is further configured to execute the computer-executable instructions to:
identify a respective set of one or more attributes associated with each electronic loan document in the set of one or more electronic loan documents; and
determine the respective classification for each electronic loan document in the set of one or more electronic loan documents based at least in part on the respective set of one or more attributes.

9. The system of claim 8, wherein, to determine the respective classification for each electronic loan document, the at least one processor is configured to execute the computer-executable instructions to:
identify one or more classification criteria associated with the respective classification; and
determine that the respective set of one or more attributes satisfies at least one of the one or more classification criteria associated with the respective classification.

10. The system of claim 9, wherein, to determine that the respective set of one or more attributes satisfies at least one of the one or more classification criteria, the at least one processor is configured to execute the computer-executable instructions to:
determine, based at least in part on the at least one of the one or more classification criteria, that the respective set of one or more attributes satisfies a classification confidence level associated with the respective classification.

11. The system of claim 9, wherein the one or more classification criteria comprise a criterion relating to a level of correspondence between one or more character strings associated with the respective classification and text included in the electronic loan document.

12. The system of claim 11, wherein the one or more classification criteria further comprise at least one of:
i) a criterion relating to a respective physical or logical location associated with each of the one or more character strings associated with the respective classification,
ii) a criterion relating to an association between the electronic loan document and one or more tags associated with the one or more character strings,
iii) a criterion relating to a respective parameter that indicates, for each of the one or more character strings, whether presence of the each of the one or more character strings in the electronic loan document is mandatory or optional,
iv) a criterion relating to a level of correspondence between one or more alternate character strings and the text included in the electronic loan document, wherein the one or more alternate character strings are associated with the one or more character strings, or
v) a criterion relating to a respective matching confidence level associated with each of the one or more character strings, wherein the respective matching confidence level specifies a minimum threshold level of correspondence desired between the each of the one or more character strings and a respective corresponding character string of the text included in the electronic loan document.

13. The system of claim 8, wherein, to determine the respective classification for each electronic loan document, the at least one processor is configured to execute the computer-executable instructions to:
identify a plurality of candidate classifications;
determine, for each electronic loan document, a respective set of correspondence metrics, wherein each correspondence metric in the respective set of correspondence metrics is indicative of a level of correspondence between the respective set of one or more attributes and each of the plurality of candidate classifications; and
determine, for each electronic loan document, a respective one correspondence metric of the respective set of correspondence metrics, wherein the respective one correspondence metric is associated with the respective classification.

14. The system of claim 1, wherein, to perform extraction processing, the at least one processor is configured to execute the computer-executable instructions to:
identify a respective set of one or more data fields associated with at least one electronic loan document in the set of one or more electronic loan documents based at least in part on the respective classification; and
analyze the at least one electronic loan document to identify the set of one or more data elements, wherein each data element in the set of one or more data elements corresponds to a respective one data field of the set of one or more data fields.

15. The system of claim 14, wherein the at least one processor is further configured to execute the computer-executable instructions to:
identify a respective set of one or more extraction criteria associated with each data field in the set of one or more data fields,
wherein each data element in the set of one or more data elements is identified based at least in part on the respective set of one or more extraction criteria.

16. The system of claim 1, wherein the at least one processor is further configured to execute the computer-executable instructions to:
generate a respective set of one or more metrics associated with at least one of: i) the classification processing or ii) the extraction processing performed for each of one or more of the electronic loan documents in the set of one or more electronic loan documents.

17. The system of claim 16, wherein the respective set of one or more metrics comprises at least one of:
i) a metric relating to a classification confidence level associated with the classification processing,
ii) a metric relating to a number of data elements extracted by the extraction processing,
iii) a metric relating to a level of correspondence between a set of one or more data fields associated with the respective classification and a respective one or more data elements in the set of one or more data elements, or
iv) a metric relating to an extraction confidence level associated with the extraction processing.

18. The system of claim 1, wherein the at least one processor is further configured to execute the computer-executable instructions to:
store the set of one or more electronic loan documents in one or more datastores.

19. The system of claim 18, wherein the at least one processor is further configured to execute the computer-executable instructions to:
store respective metadata in association with each of at least one electronic loan document in the set of one or more electronic loan documents, wherein the respective metadata identifies: i) the respective classification associated with each of the at least one electronic loan document, ii) a respective one or more data elements in the set of one or more data elements, and iii) a respective set of one or more metrics associated with at least one: i) the classification processing or ii) the extraction processing.

20. The system of claim 1, wherein the at least one processor is further configured to execute the computer-executable instructions to:
identify a respective comparison template associated with each of at least one respective classification, wherein the respective comparison template comprises a respective at least one textual comparison in the set of one or more textual comparisons.

21. The system of claim 1, wherein each textual comparison in the set of one or more textual comparisons comprises a respective one of:
i) an inclusion comparison,
ii) an exclusion comparison, or
iii) a relative comparison.

22. The system of claim 1, wherein each textual comparison in the set of one or more textual comparisons is associated with a respective minimum threshold level of correspondence, and wherein the respective minimum threshold level of correspondence comprises one of:
i) a comparison threshold level,
ii) a total number of matching characters,
iii) a percentage of matching characters, or
iv) a numerical statistical limit.

23. The system of claim 1, wherein each comparison result in the set of one or more comparison results corresponds to a respective one textual comparison and comprises a respective one of:
i) a success result indicating that the comparison processing indicates that a respective minimum threshold level of correspondence associated with the respective one textual comparison is satisfied, or
ii) an exception result indicating one of: i) that the comparison processing indicates that the respective minimum threshold level of correspondence associated with the respective one textual comparison is not satisfied or ii) that no data from the external source was available for performing the respective one textual comparison.

24. The system of claim 23, wherein, to determine whether the loan is a candidate for delivery to one or more target parties, the at least one processor is configured to execute the computer-executable instructions to:
determine that each of at least one comparison result in the set of one or more comparison results comprises a respective exception result.

25. The system of claim 24, wherein the at least one processor is further configured to execute the computer-executable instructions to:
determine, based at least in part on the determination that each of the at least one comparison result comprises the respective exception result, that the loan does not satisfy a minimum quality threshold; and
determine that the loan is not a candidate for delivery based at least in part on determining that the loan does not satisfy the minimum quality threshold.

26. The system of claim 24, wherein the at least one processor is further configured to execute the computer-executable instructions to:
facilitate resolution of at least one respective exception result.

27. The system of claim 26, wherein the at least one processor is further configured to execute the computer-executable instructions to:
determine, based at least in part on resolution of the at least one respective exception result, that the loan satisfies the minimum quality threshold; and
determine that the loan is a candidate for delivery based at least in part on determining that the loan satisfies the minimum quality threshold.

28. The system of claim 1, wherein it is determined that the loan is a candidate for delivery to one or more target parties, and wherein the at least one processor is further configured to execute the computer-executable instructions to:
identify the one or more target parties;
identify a respective set of one or more delivery requirements associated with each of at least one target party of the one or more target parties;
perform pre-delivery processing associated with the at least one target party, wherein the pre-delivery processing comprises respective pre-delivery processing associated with each target party of the at least one target party, and wherein the respective pre-delivery processing is based at least in part on the respective set of one or more delivery requirements; and
determine whether to perform delivery processing of the loan based at least in part on a set of one or more results associated with the pre-delivery processing.

29. The system of claim 28, wherein, to determine whether to perform delivery processing of the loan, the at least one processor is configured to execute the computer-executable instructions to:
determine that the set of one or more results comprises a result indicating failure of the pre-delivery processing performed with respect to a corresponding target party of the at least one target party; and
determine not to perform delivery processing of the loan responsive to determining that the set of one or more results comprises the result indicating failure.

30. The system of claim 28, wherein, to determine whether to perform delivery processing of the loan, the at least one processor is configured to execute the computer-executable instructions to:
determine that the set of one or more results comprises a result indicating success of the pre-delivery processing performed with respect to a corresponding target party of the at least one target party; and
determine to perform delivery processing of the loan responsive to determining that the set of one or more results comprises the result indicating success.

31. The system of claim 28, wherein it is determined to perform delivery processing of the loan, and wherein the at least one processor is further configured to execute the computer-executable instructions to:
identify each target party of the at least one target party for which the respective pre-delivery processing was successful;
identify respective delivery information associated with each target party for which the respective pre-delivery processing was successful; and
deliver or direct delivery of, based at least in part on the respective delivery information, a respective at least a portion of the loan to a respective corresponding target party for which the respective pre-delivery processing was successful.

32. A method, comprising:
identifying, by the loan processing system, a set of one or more electronic loan documents;
performing, by the loan processing system, classification processing to determine a respective classification for each electronic loan document in the set of one or more electronic loan documents;
performing, by the loan processing system, extraction processing to extract a set of one or more data elements, wherein each data element in the set of one or more data elements is extracted from a respective corresponding electronic loan document based at least in part on the respective classification;
identifying, by the loan processing system, a set of one or more textual comparisons, wherein each textual comparison in the set of one or more textual comparisons specifies a comparison to be performed between a respective at least one data element in the set of one or more data elements and a respective at least one data element from an external data source;
performing, by the loan processing system, comparison processing based at least in part on the set of one or more textual comparisons to generate a set of one or more comparison results; and
determining, by the loan processing system and based at least in part on at least a portion of the set of one or more comparison results, whether the loan is a candidate for delivery to one or more target parties.

33. The method of claim 32, further comprising:
receiving, by the loan processing system, a set of one or more documents; and
converting, by the loan processing system, the set of one or more documents to the set of one or more electronic documents.

34. The method of claim 32, further comprising:
identifying, by the loan processing system, a respective set of one or more attributes associated with each electronic loan document in the set of one or more electronic loan documents; and
determining, by the loan processing system, the respective classification for each electronic loan document in the set of one or more electronic loan documents based at least in part on the respective set of one or more attributes.

35. The method of claim 34, wherein determining the respective classification for each electronic loan document comprises:
identifying, by the loan processing system, a plurality of candidate classifications;
determining, by the loan processing system and for each electronic loan document, a respective set of correspondence metrics, wherein each correspondence metric in the respective set of correspondence metrics is indicative of a level of correspondence between the respective set of one or more attributes and each of the plurality of candidate classifications;
determining, by the loan processing system and for each electronic loan document, a respective one correspondence metric of the respective set of correspondence metrics, wherein the respective one correspondence metric is associated with the respective classification.

36. The method of claim 32, wherein performing extraction processing comprises:
identifying, by the loan processing system, a respective set of one or more data fields associated with at least one electronic loan document in the set of one or more electronic loan documents based at least in part on the respective classification; and
analyzing, by the loan processing system, the at least one electronic loan document to identify the set of one or more data elements, wherein each data element in the set of one or more data elements corresponds to a respective one data field of the set of one or more data fields.

37. The method of claim 32, wherein performing extraction processing comprises:
identifying, by the loan processing system, a respective set of one or more extraction criteria associated with each data field in the set of one or more data fields,
wherein each data element in the set of one or more data elements is identified based at least in part on the respective set of one or more extraction criteria.

38. The method of claim 32, further comprising:
generating, by the loan processing system, a respective set of one or more metrics associated with at least one of: i) the classification processing or ii) the extraction processing performed for each of one or more of the electronic loan documents in the set of one or more electronic loan documents.

39. The method of claim 38, wherein the respective set of one or more metrics comprises at least one of:
i) a metric relating to a classification confidence level associated with the classification processing,
ii) a metric relating to a number of data elements extracted by the extraction processing,
iii) a metric relating to a level of correspondence between a set of one or more data fields associated with the respective classification and a respective one or more data elements in the set of one or more data elements, or
iv) a metric relating to an extraction confidence level associated with the extraction processing.

40. The method of claim 32, further comprising:
identifying, by the loan processing system, a respective comparison template associated with each of at least one respective classification, wherein the respective comparison template comprises a respective at least one textual comparison in the set of one or more textual comparisons.

41. The method of claim 32, wherein each comparison result in the set of one or more comparison results corresponds to a respective one textual comparison and comprises a respective one of:
i) a success result indicating that the comparison processing indicates that a respective minimum threshold level of correspondence associated with the respective one textual comparison is satisfied, or
ii) an exception result indicating one of: i) that the comparison processing indicates that the respective minimum threshold level of correspondence associated with the respective one textual comparison is not satisfied or ii) that no data from the external source was available for performing the respective one textual comparison.

42. The method of claim 41, wherein determining whether the loan is a candidate for delivery to one or more target parties comprises:
determining, by the loan processing system, that each of at least one comparison result in the set of one or more comparison results comprises a respective exception result.

43. The method of claim 42, further comprising:
determining, by the loan processing system and based at least in part on the determination that each of the at least one comparison result comprises the respective exception result, that the loan does not satisfy a minimum quality threshold; and
determining, by the loan processing system, that the loan is not a candidate for delivery based at least in part on determining that the loan does not satisfy the minimum quality threshold.

44. The method of claim 43, further comprising:
facilitating, by the loan processing system, resolution of at least one respective exception result.

45. The method of claim 44, further comprising:
determining, by the loan processing system and based at least in part on resolution of the at least one respective exception result, that the loan satisfies the minimum quality threshold; and
determining, by the loan processing system, that the loan is a candidate for delivery based at least in part on determining that the loan satisfies the minimum quality threshold.

46. The method of claim 32, wherein it is determined that the loan is a candidate for delivery to one or more target parties, further comprising:
identifying, by the loan processing system, the one or more target parties;
identifying, by the loan processing system, a respective set of one or more delivery requirements associated with each of at least one target party of the one or more target parties;
performing, by the loan processing system, pre-delivery processing associated with the at least one target party, wherein the pre-delivery processing comprises respective pre-delivery processing associated with each target party of the at least one target party, and wherein the respective pre-delivery processing is based at least in part on the respective set of one or more delivery requirements; and
determining, by the loan processing system, whether to perform delivery processing of the loan based at least in part on a set of one or more results associated with the pre-delivery processing.

47. The method of claim 46, wherein determining whether to perform delivery processing of the loan comprises:
determining, by the loan processing system, that the set of one or more results comprises a result indicating failure of the pre-delivery processing performed with respect to a corresponding target party of the at least one target party; and
determining, by the loan processing system, not to perform delivery processing of the loan responsive to determining that the set of one or more results comprises the result indicating failure.

48. The method of claim 46, wherein determining whether to perform delivery processing of the loan comprises:
determining, by the loan processing system, that the set of one or more results comprises a result indicating success of the pre-delivery processing performed with respect to a corresponding target party of the at least one target party; and
determining, by the loan processing system, to perform delivery processing of the loan responsive to determining that the set of one or more results comprises the result indicating success.

49. The method of claim 46, wherein it is determined to perform delivery processing of the loan, further comprising:
identifying, by the loan processing system, each target party of the at least one target party for which the respective pre-delivery processing was successful;
identifying, by the loan processing system, respective delivery information associated with each target party for which the respective pre-delivery processing was successful; and
delivering or directing the delivery of, by the loan processing and based at least in part on the respective delivery information, a respective at least a portion of the loan to a respective corresponding target party for which the respective pre-delivery processing was successful.
